(19) United States
(12) Patent Application Publication
(10) Pub. No.: US 2025/0124255 A1
(43) Pub. Date: Apr. 17, 2025

(54) EFFICIENT DECODING USING LARGE AND SMALL GENERATIVE ARTIFICIAL INTELLIGENCE MODELS

(71) Applicant: QUALCOMM Incorporated, San Diego, CA (US)

(72) Inventors: Benjamin BERGNER, Amsterdam (NL); Andrii SKLIAR, Diemen (NL); Babak EHTESHAMI BEJNORDI, Amsterdam (NL); Yuki Markus ASANO, Amsterdam (NL); Tijmen Pieter Frederik BLANKEVOORT, Amsterdam (NL); Joseph Binamira SORIAGA, San Diego, CA (US)

(21) Appl. No.: 18/486,653

(22) Filed: Oct. 13, 2023

(51) Int. Cl. G06N 3/0455; G06N 3/0475

(52) U.S. Cl. CPC G06N 3/0455; G06N 3/0475

(57) ABSTRACT

Certain aspects of the present disclosure provide techniques and apparatus for generating a response to an input query using a generative artificial intelligence model. The method generally includes receiving an input query for processing. Using a first generative artificial intelligence model, an embedding representation of the received input query is generated. The embedding representation generally includes an embedding of the received input query in a first dimensionality. The embedding representation is projected into a projected representation of the received input query. Generally, the projected representation comprises a representation in a second dimensionality. A response to the received input query is generated using a second generative artificial intelligence model and the projected representation, and the generated response is output.

### INTRODUCTION

Aspects of the present disclosure relate to generative artificial intelligence models.

Generative artificial intelligence models can be used in various environments in order to generate a response to an input query. For example, generative artificial intelligence models can be used in chatbot applications in which large language models (LLMs) are used to generate an answer, or at least a response, to an input query. Other examples in which generative artificial intelligence models can be used include stable diffusion, in which a model generates an image from an input text description of the content of the desired image, and decision transformers, in which future actions are predicted based on sequences of prior actions within a given environment.

Generally, generating a response to a query using generative artificial intelligence models may be computationally expensive. For example, in a chatbot deployment in which a large language model is used to generate a response to a query formatted as a text query, a response to the query may be generated using a pass through the large language model for each token (e.g., a word or part of a word) generated as part of the response. The output of each pass may be a probability distribution on a set of tokens (words) from which the next token (word) may be selected, either by sampling or based on maximum likelihood, for example. Because a pass through a large language model is used to generate each word (or token) in a response to a query, the computational expense may be modeled as the product of the number of words included in the response and the computational resource expense (e.g., in terms of processing power, memory bandwidth, and/or other compute resources used) of performing a pass through the large language model, which generally increases as the number of parameters within the large language model increases.

### BRIEF SUMMARY

Certain aspects of the present disclosure provide a processor-implemented method for generating a response to an input query using a generative artificial intelligence model. The method generally includes receiving an input query for processing. Using a first generative artificial intelligence model, an embedding representation of the received input query is generated. The embedding representation generally includes an embedding of the received input query in a first dimensionality. The embedding representation is projected into a projected representation of the received input query. Generally, the projected representation comprises a representation in a second dimensionality, and the second dimensionality is smaller than the first dimensionality. A response to the received input query is generated using a second generative artificial intelligence model and the projected representation, and the generated response is output.

Other aspects provide processing systems configured to perform the aforementioned methods as well as those described herein; non-transitory computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 illustrates an example pipeline for using a large generative artificial intelligence model and a small generative artificial intelligence model to generate a response to an input, according to aspects of the present disclosure.

FIG. 2 illustrates an example of iterative generation of sets of tokens using a large generative artificial intelligence model and a small generative artificial intelligence model, according to aspects of the present disclosure.

FIG. 3 illustrates an example pipeline for generating a response to an input using a large language model and a small language model, according to aspects of the present disclosure.

FIG. 4 illustrates an example pipeline for generating a response to an input using a large language model and a small language model, according to aspects of the present disclosure.

FIG. 5 illustrates example operations for generating a response to an input query using a large generative artificial intelligence model and a small generative artificial intelligence model, according to aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for efficiently generating responses to input queries using generative artificial intelligence models.

Generally, generative artificial intelligence models generate a response to a query input into the model. For example, a large language model (LLM) deployed within a chatbot can generate a response to a query using multiple passes through the large language model, with each successive pass being based on the query and the token(s) (or word(s) or parts of words) generated using previous passes through the large language model. Generally, these large language models may include millions, or even billions, of weights or parameters within the model. Because of the size of these models and the operations performed on each token to predict what should be the next token generated in response to a query and the previously generated tokens, it may not be practical, or even possible, to deploy large language models on a variety of devices which may have limited memory, storage, and/or processing capabilities relative to cloud compute instances on which large language models typically operate. Further, the computational complexity involved in generating a response to a query provided as input into a model may involve significant energy expenditure, processing time, memory utilization, and other resource utilization, which may prevent compute resources from being used for other tasks.

Various techniques can be used to improve the efficiency of generating responses to input queries using generative artificial intelligence models. In some examples, queries may be processed using a cascade of generative artificial intelligence models. The cascade of generative artificial intelligence models may include a plurality of generative models, each trained over different numbers of tokens, and a scoring model. The scoring model generally predicts a likelihood that a particular generative model from the plurality of generative models is likely to generate a correct answer to an input. These predicted likelihoods, along with a threshold value, can be used to determine when to accept a response generated by the plurality of generative models and proceed with generating a subsequent response to the input and any previously generated tokens.

In other examples, speculative decoding techniques allow for a smaller generative model, sometimes known as a draft large language model (also referred to as a draft model or a small model), to execute in parallel with a larger generative model, sometimes known as a target large language model (also referred to as a target model or a large model). In such a case, the draft model, which may be a pruned version of the target model chosen such that the draft model and target model have similar probability distributions or may be a smaller version of the target model (e.g., trained on millions of tokens, instead of hundreds of millions or even billions of tokens), can generate speculatively additional tokens and probabilities used for sampling these additional tokens based on a current set of accepted tokens. The target model can generate tokens based on the tokens generated by the draft model. To generate a result, the target model can perform rejection sampling on a per-token basis to accept or reject tokens generated by the draft model such that the draft model and the target model have similar probability distributions.

However, these techniques still rely on the generation of tokens using large generative models. As discussed, these large generative models are able to generate responses to input queries on a per-token basis. However, there is typically a significant computational expense involved in generating tokens using a large generative model that greatly exceeds the computational expense involved in generating tokens using a smaller generative model. Further, because small generative models may be able to generate many tokens included in a response to an input query, the additional computational expense involved in generating tokens using a large generative model may be wasted.

Aspects of the present disclosure provide techniques for generating responses to an input query using a large generative model (which may be referred to as a first generative model) and a small generative model (which may be referred to as a second generative model), the large generative model being larger than the small generative model. Generally, the large generative model generates an embedding representation of the input query, which can be projected into a lower-dimensional space. The projected embedding representation of the input query can then be used by a small generative model to generate a response to the input query. Generally, the small generative model can use the projected embedding representation of the input query to generate a number of tokens up to a threshold number of tokens. An embedding representation of the generated tokens, generated by the large generative model, along with the embedding representation of the input query, can be used as an input into the small generative model to generate subsequent tokens. By using the large generative model to generate an embedding representation of an input query, which may be computationally inexpensive relative to the computational expense involved in generating tokens using a generative model, aspects of the present disclosure can condition the small generative model to generate a response to the input query based on knowledge in a higher-dimensional domain (e.g., the dimensionality of the domain associated with the large generative model, which may be higher than the dimensionality of the domain associated with the small generative model) extracted from the input query. Thus, the generation of a response to an input query can be performed using fewer compute resources (e.g., processor cycles, memory utilization, etc.) than the amount of compute resources used in autoregressively generating a response to an input query using a large generative model.

### Example Response Generation to an Input Query Using a Large Generative Artificial Intelligence Model and a Small Generative Artificial Intelligence Model

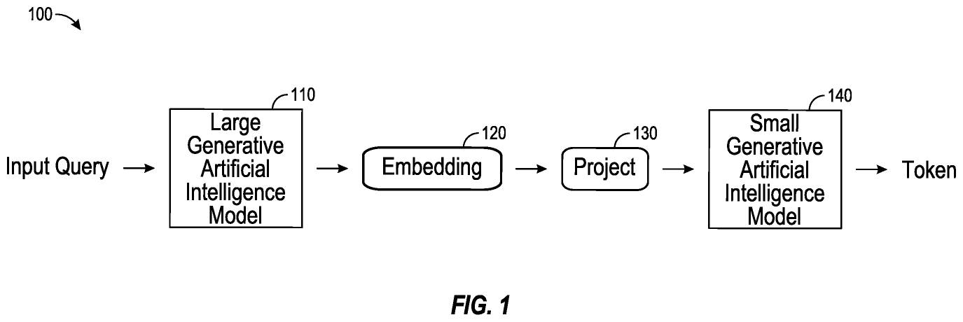

FIG. 1 illustrates an example pipeline 100 for using a large generative artificial intelligence model and a small generative artificial intelligence model to generate a response to an input, according to aspects of the present disclosure.

As illustrated, the pipeline 100 includes a large generative artificial intelligence model 110, a projection module 130, and a small generative artificial intelligence model 140 (also referred to herein as an “SGM”). Generally, the large generative artificial intelligence model 110 and the small generative artificial intelligence model 140 may be models trained to generate a response over different numbers of parameters (e.g., tokens). For example, the large generative artificial intelligence model 110 may be trained to generate a response based on a training data corpus including tens of billions or even hundreds of billions of tokens, while the small generative artificial intelligence model 140 may be trained to generate a response from a universe based on a training data corpus including a significantly smaller number of tokens. Because of the number of parameters associated with the large generative artificial intelligence model 110 is significantly larger than the number of parameters associated with the small generative artificial intelligence model 140, the computational expense involved in generating a response to an input query (or input prompt) using the large generative artificial intelligence model 110 may be significantly higher than the computational expense involved in generating a response to the input query using the small generative artificial intelligence model 140. However, while generating a response to an input query using the large generative artificial intelligence model 110 may be a computationally expensive process, generating an embedding representation 120 of the input query using the large generative artificial intelligence model 110 may be a computationally inexpensive process.

Thus, to efficiently generate a response to the input query, the large generative artificial intelligence model 110 generates an embedding representation 120 of the input query. The embedding representation 120 of the input query generally may be a set of data (e.g., a vector) representing the input query in a high-dimensional space (e.g., a space defined by a large number of parameters into which a representation of the input query can be mapped). Because the embedding representation 120 represents the input query in a high-dimensional space, the embedding representation 120 generally encodes the semantic meaning of the input query in a representation that can be used downstream of the large generative artificial intelligence model 110 in generating a response to the input query. In some aspects, the embedding representation 120 may correspond to a summary of the input query that retains semantically important information from the input query but discards semantically unimportant information from the input query (e.g., filler words in a natural language query, semantically unimportant phrases, etc.).

Because this embedding representation 120 is generated by a large generative artificial intelligence model 110 in a higher dimensionality than the dimensionality of the small generative artificial intelligence model 140, the embedding representation can embed, in a compact representation, information from a large number of dimensions that the small generative artificial intelligence model 140 can use to generate a response, while reducing the computational expense of generating a response to an input query using the large generative artificial intelligence model 110 (which may be a significantly more resource-intensive and computationally expensive process than generating an embedding representation of the input query).

In some aspects, as illustrated, the embedding representation 120 can be input into the projection module 130. The projection module 130 may be a model trained to align the small generative artificial intelligence model 140 with the large generative artificial intelligence model 110 so that the output of the large generative artificial intelligence model 110 is usable by the small generative artificial intelligence model 140. To make the output of the large generative artificial intelligence model 110 usable by the small generative artificial intelligence model 140, in some aspects, the projection module 130 may be a model that reduces the dimensionality of the embedding representation 120 of the input query to a dimensionality corresponding to a universe of parameters over which the small generative artificial intelligence model 140 was trained.

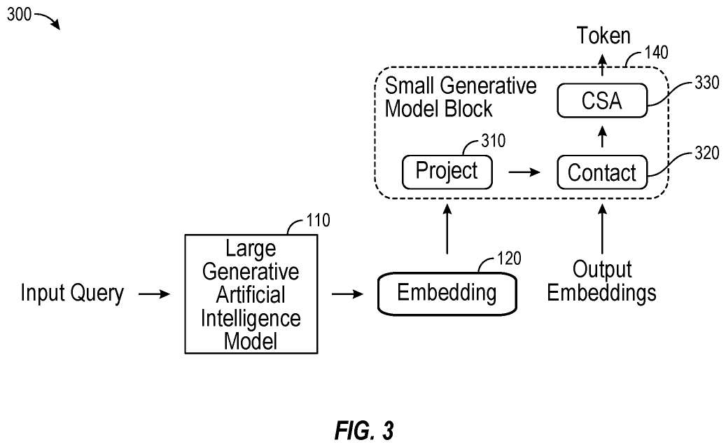

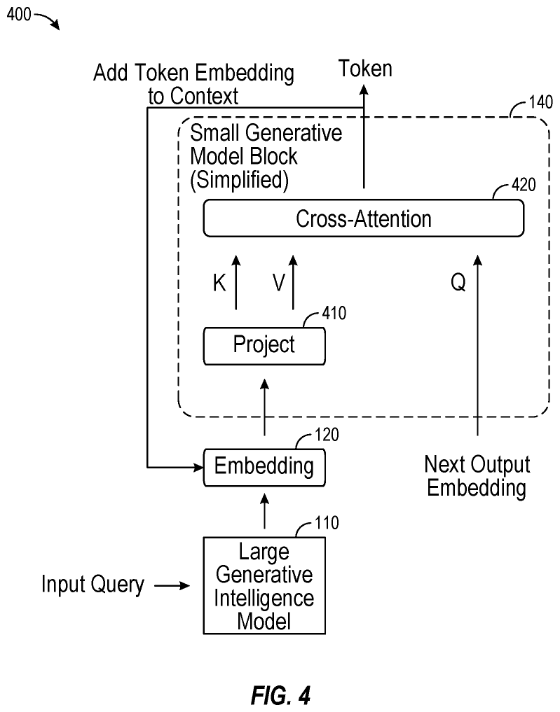

In some aspects, as illustrated in FIG. 1, the projection module 130 may be a learned layer that is interposed between the large generative artificial intelligence model 110 and the small generative artificial intelligence model 140. In this example, the large generative artificial intelligence model 110 and the small generative artificial intelligence model 140 may be frozen pre-trained models, and the projection module 130 may be a model trained based on embeddings generated by the large generative artificial intelligence model 110 and the small generative artificial intelligence model 140 for query samples included in a training data set (not illustrated in FIG. 1). In some aspects, and as discussed in further detail below with respect to FIGS. 3 and 4, the projection module 130 may be a component of the small generative artificial intelligence model 140 that projects the embedding representation 120 of the input query (and, in some aspects, tokens generated by the small generative artificial intelligence model 140 or embedding representations thereof) into a space with a dimensionality corresponding to the universe of parameters over which the small generative artificial intelligence model 140 was trained.

The small generative artificial intelligence model 140 generally uses the projected embedding representation of the input query (and, in some aspects, tokens previously generated by the small generative artificial intelligence model 140 or embedding representations thereof) to generate a response to the input query. In some aspects, the response may include one or more tokens, corresponding to words in a natural language output generated as a response to a natural language input query, generated autoregressively by the small generative artificial intelligence model 140. Generally, in generating the tokens to be included in a response to the input query, the small generative artificial intelligence model 140 can generate tokens based on historical tokens, according to the expression:

$${x}_{t} ∼ p ( x \vert {x}_{0} , {x}_{1} , … , {x}_{t - 1} ) \qquad \to \qquad {x}_{t + 1} ∼ p ( x \vert {x}_{0} , {x}_{1} , … , {x}_{t - 1} , {x}_{t} )$$

where xₜ represents a sequence of tokens generated at time t, having a conditional probability p conditioned on the selection of tokens x₀ through xₜ₋₁, and xₜ₊₁ represents a sequence of tokens generated at time t+1, having a conditional probability p conditioned on on the selection of tokens x₀ through xₜ. Generally, a single token may be generated through each pass through the small generative artificial intelligence model 140.

The generated response to the input query may be output by the small generative artificial intelligence model 140. In some aspects, the response may be provided, along with the input query, to the large generative artificial intelligence model 110 to begin the generation of a subsequent set of tokens to be included as part of the response to the input query. In some aspects, where the small generative artificial intelligence model 140 has determined that no further tokens are to be included in the response generated by the small generative artificial intelligence model 140 or the small generative model 140 has reached some other terminating condition (e.g., a point at which no tokens have probabilities that exceed a threshold probability for selection for inclusion in a generated response or a point at which the response includes a maximum number of tokens), the small generative artificial intelligence model 140 can output the generated response and terminate further inferencing operations in respect of the input query.

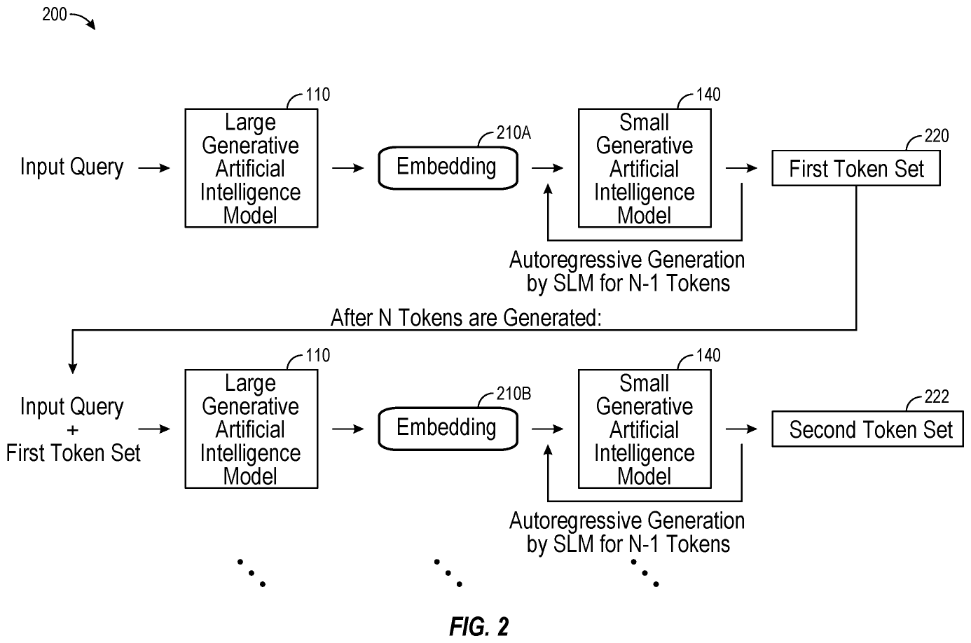

FIG. 2 illustrates an example 200 of iterative generation of sets of tokens using a large generative artificial intelligence model and a small generative artificial intelligence model, according to aspects of the present disclosure.

In the example 200, an input query is received for processing at the large generative artificial intelligence model 110. As discussed above, the large generative artificial intelligence model 110 does not generate a response to the received input query, but instead generates an embedding representation 210A, which can be fed as input into the small generative artificial intelligence model 140. The embedding representation 210A generally corresponds to a representation of the input query in a multidimensional space. The embedding representation 210A may represent a semantic summary of the input query in the multidimensional space, and the semantic summary may include information about semantically relevant portions of the input query and relationships between these semantically relevant portions of the input query. In some aspects, the embedding representation 210A may assign no weight to semantically irrelevant portions of the input query, such as stop words, articles, or other language components that do not significantly affect the meaning of the input query.

The embedding representation 210A may be provided as input to the small generative artificial intelligence model 140 for use in generating a first token set 220. Though not illustrated in FIG. 2, the embedding representation 210A may be projected from the larger dimensionality space of the large generative artificial intelligence model 110 to the smaller dimensionality space of the small generative artificial intelligence model 140 prior to the small generative artificial intelligence model 140 generating a response to the input query. Generally, the small generative artificial intelligence model 140 may be configured to autoregressively generate up to a threshold number N of tokens for a given input into the small generative artificial intelligence model 140. Generally, as discussed above, the small generative artificial intelligence model 140 can autoregressively generate the first token set 220 by generating an initial token x₁ based on the embedding representation 210A of the input query (which, as discussed, may be projected into the lower-dimensional space associated with the small generative artificial intelligence model 140). In some aspects, the initial token x₁ may be selected based on a probability distribution generated by the small generative artificial intelligence model 140 given an input of the embedding representation 210A of the input query, where the token x₁ corresponds to the token having the highest probability score, or a probability score within a threshold value of the highest probability scores, in the probability distribution.

Tokens x₂ through x_{N} may be generated by the small generative artificial intelligence model 140 based on a conditional probability distribution generated by the small generative artificial intelligence model 140. The conditional probability distribution may generally correspond to the probability distribution over a universe of tokens, conditioned on the input query (or projected representation thereof) and the tokens previously generated by the small generative artificial intelligence model 140. That is, the second token x₂ may be generated based on the input query (or the embedding representation 210A thereof) and the selection of the first token x₁. The third token x₃, meanwhile, may be generated based on the input query and the selection of the first token x₁ and the second token x₂. This process may continue for each successively generated token until N tokens are generated by the small generative artificial intelligence model 140.

While the probability distributions associated with the large generative artificial intelligence model 110 and the small generative artificial intelligence model 140 may mirror each other, or at least be similar, at the beginning of a token generation process, generation of tokens by the small generative artificial intelligence model 140 may cause the probability distribution associated with the small generative artificial intelligence model 140 to diverge from that of the large generative artificial intelligence model 110 over time. Thus, if left unchecked, the small generative artificial intelligence model 140 may, in some cases, begin to generate a response to an input query that significantly diverges from a response that would have been generated by the large generative artificial intelligence model 110. To minimize, or at least reduce, this divergence, aspects of the present disclosure may define a threshold number of tokens that the small generative artificial intelligence model 140 can generate before the large generative artificial intelligence model 110 generates an updated embedding to incorporate information about the input query and the tokens generated by the small generative artificial intelligence model 140 into the input of the small generative artificial intelligence model 140.

To generate a second token set 222 serving as a part of an overall response to the input query (along with the first token set 220), the input query and the first token set 220 may be input into the large generative artificial intelligence model 110 for processing into an updated embedding representation 210B. The updated embedding representation 210B may thus correspond to a semantically aware representation of the input query and the first token set 220, and as such the updated embedding representation 210B can be used to generate the second token set 222 through the small generative artificial intelligence model 140. As discussed above with respect to the embedding representation 210A of the input query, the large generative artificial intelligence model 110 generally creates a representation of the input query (along, in some aspects, with the first token set 220) and may, in some aspects, generate an embedding in a higher-dimensional space than the dimensionality of the small generative artificial intelligence model 140. As with the example discussed above, once the threshold number of tokens in the second token set 222 has been generated, aspects of the present disclosure may output the second token set 222 for further use (e.g., as a further conditioning signal used to influence the generation of even further sets of tokens).

In some cases, to allow for the small generative artificial intelligence model 140 to accurately generate responses to an input query (e.g., to generate a response similar to, if not the same as, that proposed to be a response by the large generative artificial intelligence model 110), the large generative artificial intelligence model 110 and the small generative artificial intelligence model 140 may be jointly finetuned. In some aspects, this joint finetuning of the large generative artificial intelligence model 110 and the small generative artificial intelligence model 140 may involve the adjustment of one or more parameters for one or both of the large generative artificial intelligence model 110 and/or the small generative artificial intelligence model 140 such that the probability distributions associated with the large generative artificial intelligence model 110 and the small generative artificial intelligence model 140 diverge by less than some threshold amount after generation of the threshold number of tokens by the small generative artificial intelligence model 140.

FIG. 3 illustrates an example pipeline 300 for generating a response to an input query using a large language model and a small language model, according to aspects of the present disclosure. The example pipeline 300 may be used, for example, to generate the token sets 220 and 222 illustrated in FIG. 2 and described above.

As illustrated, in the pipeline 300, a response to a received input query may be generated by inputting the received input query into the large generative artificial intelligence model 110. As discussed above, the large generative artificial intelligence model 110 generates an embedding representation 120 of the input query. The generated embedding representation 120 of the input query is then provided as input into the small generative artificial intelligence model 140 (or a block within a small generative artificial intelligence model) for use in generating a response to the received input query.

In the pipeline 300, the small generative artificial intelligence model 140 includes a projection module 310, a concatenation module 320, and a causal self-attention (CSA) block 330. The projection module 310 may correspond to the projection module 130 illustrated in FIG. 1 and discussed in further detail above. Generally, the projection module 310 comprises a trained machine learning model trained to project the embedding representation 120 of the input query from a first dimensionality associated with the large generative artificial intelligence model 110 to a second (smaller) dimensionality associated with the small generative artificial intelligence model 140. By doing so, as discussed, relevant features or other relevant data extracted by the large generative artificial intelligence model 110 can be used by the small generative artificial intelligence model 140 to generate a response, or at least a portion of a response.

The projection of the embedding representation 120 of the input query may be input into the concatenation module 320, which combines the projection of the embedding representation 120 of the input query with embeddings of selected output tokens, to create a combined embedding. The combined embedding is then input into the causal self-attention block 330 for processing. For example, the causal self-attention block 330 may be a transformer neural network that uses key, query, and value data to generate an output. In this example, the causal self-attention block 330 generates tokens to be included in a response to the input query based on the projected embedding representation of the input query and, if any such information exists, information (e.g., embedding representations) of tokens that have previously been generated as part of a response to the input query. Generally, the causal self-attention block 330 can use information about previously generated tokens to influence the selection of the next token to be included in a response to the input query, but may not use information about downstream tokens to influence selection of the next token.

When the pipeline 300 processes an input query, the causal self-attention block 330 can receive as input a projection of the embedding representation of the input query. In response, the causal self-attention block 330 generates a first token x₁ based on the projection of the embedding representation 120 of the input query. Subsequently, the concatenation module 320 can concatenate the projection of the embedding representation 120 of the input query and an embedding representation of the first token x₁ and provide the concatenated projection of the embedding representation 120 of the input query and the embedding representation of the first token x₁ into the causal self-attention block 330 for generation of a second token x₂. This concatenation of embedding representations of tokens generated by the causal self-attention block 330 and the projection of the embedding representation 120 of the input query may continue until, as discussed above, the small generative artificial intelligence model 140 has generated a threshold number of tokens. At this point, the combination of the input query and the tokens generated by the small generative artificial intelligence model 140 may be input into the large generative artificial intelligence model 110. The resulting updated embedding representation generated by the large generative artificial intelligence model 110 may be used as input into the small generative artificial intelligence model 140 to trigger the generation of another set of tokens using the techniques discussed herein.

FIG. 4 illustrates an example pipeline 400 for generating a response to an input query using a large language model and a small language model, according to aspects of the present disclosure. The example pipeline 400 may be used, for example, to generate the token sets 220 and 222 illustrated in FIG. 2 and discussed above.

As illustrated, the pipeline 400 may initially operate similarly to the pipeline 300 illustrated in FIG. 3 with the provision of an input query into a large generative artificial intelligence model 110 and the resulting generation of an embedding representation 120 of the input query.

To generate a set of tokens corresponding to a response, or at least a part of a response, to the input query, the embedding representation 120 of the input query may be input into a projection module 410 for projection from a space in a first dimensionality associated with the large generative artificial intelligence model 110 to a (smaller) space in a second dimensionality associated with the small generative artificial intelligence model 140. The projection may result in the generation of keys (K) and values (V) that are provided as input into a cross-attention block 420 for use in generating a token to be included in a response to the received input query. Generally, the cross-attention block 420 generates an output of a token to be included in the response based on different embedding sequences input into the cross-attention block 420. Within the small generative artificial intelligence model 140, the embedding representation 120 of the input query may be projected into key inputs and value inputs, and query input (Q) into the cross-attention block 420 may be the embedding associated with the next predicted token to be output as part of a response to the received input query.

After the cross-attention block 420 selects a token for inclusion in the set of tokens corresponding to a response to the input query, the embedding of the token may be combined with the embedding representation 120 of the input query to generate an updated embedding representation. The updated embedding representation may be fed as input into the projection module 410 for projection into keys and values in the second dimensionality that are used as input into the cross-attention block 420. In doing so, the context based on which the cross-attention block 420 generates tokens may be autoregressively extended so that the small generative artificial intelligence model 140 can generate subsequent tokens in the response based on previously generated tokens in the response and the input query.

### Example Operations for Response Generation to an Input Query Using a Large Generative Artificial Intelligence Model and a Small Generative Artificial Intelligence Model

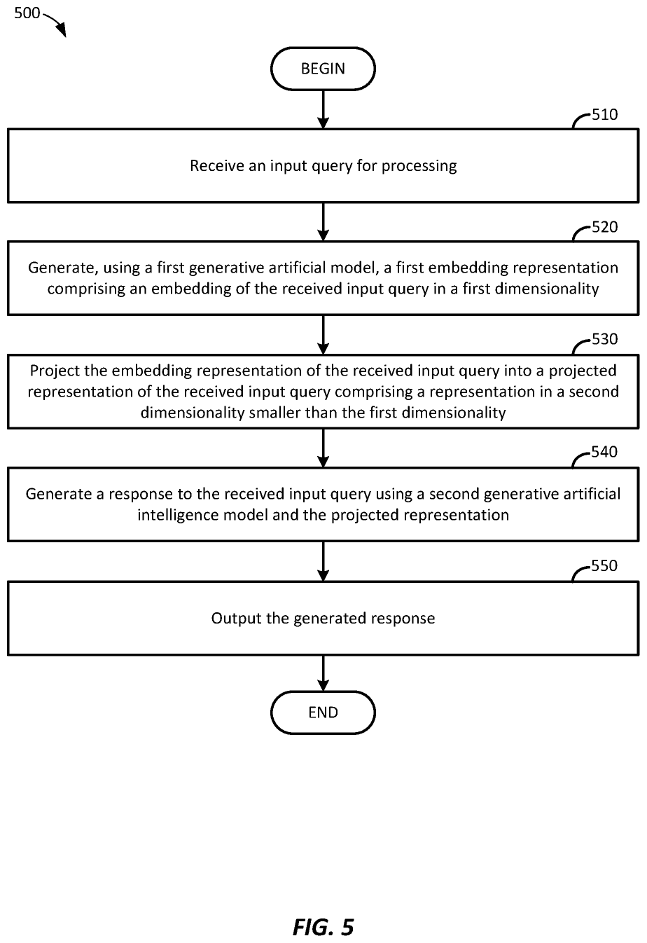

FIG. 5 illustrates example operations 500 that may be performed by a computing device to generate a response to an input query using generative artificial intelligence models, according to aspects of the present disclosure. The computing device for performing the operations 500 may be a device on which generative artificial intelligence models can be deployed, such as a smartphone, a tablet computer, a laptop computer, a desktop, a server, a cloud compute instance hosted in a distributed computing environment, or the like.

As illustrated, the operations 500 begin at block 510, with receiving an input query for processing. The input query may include, for example, a question, a prompt, or some other query that triggers the generation of a response using one or more generative artificial intelligence models. These generative artificial intelligence models may include models that generate natural language responses to natural language queries (also known as “large language models”), models that generate visual content in response to a received natural language query, or other models that are capable of generating a response to an input query or prompt.

At block 520, the operations 500 proceed with generating, using a first generative artificial intelligence model, an embedding representation of the received input query in a first dimensionality. As discussed, the embedding representation of the received input query generally includes a representation of the received input query that retains semantically relevant information contained within the received input query and strips out semantically irrelevant information from the received input query. The embedding representation may be, for example, a vector in a multidimensional space, with individual points in the vector illustrating relationships between different portions (e.g., words or groups of words) in the received input query.

At block 530, the operations 500 proceed with projecting the embedding representation of the received input query into a projected representation of the received input query. Generally, the projected representation of the received input query comprises a representation in a second dimensionality. In some aspects, the second dimensionality may be smaller than the first dimensionality.

At block 540, the operations 500 proceed with generating a response to the received input query using a second generative artificial intelligence model and the projected representation. In some aspects, the response may be generated by autoregressively generating a first set of tokens including a threshold number of tokens.

In some aspects, the operations 500 may further include generating, using the first generative artificial intelligence model, an updated embedding representation. The updated embedding representation generally includes an embedding of the received input query and the generated first set of tokens in the first dimensionality. The updated embedding representation may be projected into a projected representation of the received input query and the generated first set of tokens in the second dimensionality. Using the second generative artificial intelligence model and the projected updated embedding representation, a second set of tokens may be generated. The second set of tokens may include the threshold number of tokens.

In some aspects, generating the response using the second generative artificial intelligence model and the projected representation of the received input query may include generating one or more first tokens based on the projected representation of the received input query. The projected representation of the received input query and the generated one more first tokens may be concatenated, and the concatenation of the received input query and information related to the generated one more first tokens may be used to generate a second token. In some aspects, concatenating the projected representation and the information related to the generated one or more first tokens may include concatenating the projected representation and embedding representations of the one or more first tokens.

In some aspects, generating the response using the second generative artificial intelligence model and the projected representation of the received input query may include generating one or more first tokens based on the projected representation of the received input query. A combination of the embedding representation and the one or more first tokens may be projected into a projected representation of the received input query and the one or more first tokens. A second token may be generated based on the projected representation of the received input query and the one or more first tokens

At block 550, the operations 500 proceed with outputting the generated response.

In some aspects, the first generative artificial intelligence model comprises a model including a larger number of parameters than a number of parameters included in the second generative artificial intelligence model. For example, the number of parameters may be related to a size of the training data corpuses used to train the first generative artificial model and the second generative artificial intelligence model.

In some aspects, where the first generative artificial intelligence model and a second generative artificial intelligence model are trained together on a same target task (e.g., using transfer learning techniques in which knowledge learned during training of the first generative artificial intelligence model is re-used for training the second generative artificial intelligence model), the first generative artificial intelligence model and the second generative artificial intelligence model may be trained on a same number of tokens.

In some aspects, the first generative artificial intelligence model may be a large language model trained to generate the embedding representation in the first dimensionality. Meanwhile, the second generative artificial intelligence model may be a small language model trained to generate a response based on an input in the second dimensionality.

### Example Processing System for Response Generation to an Input Query Using a Large Generative Artificial Intelligence Model and a Small Generative Artificial Intelligence Model

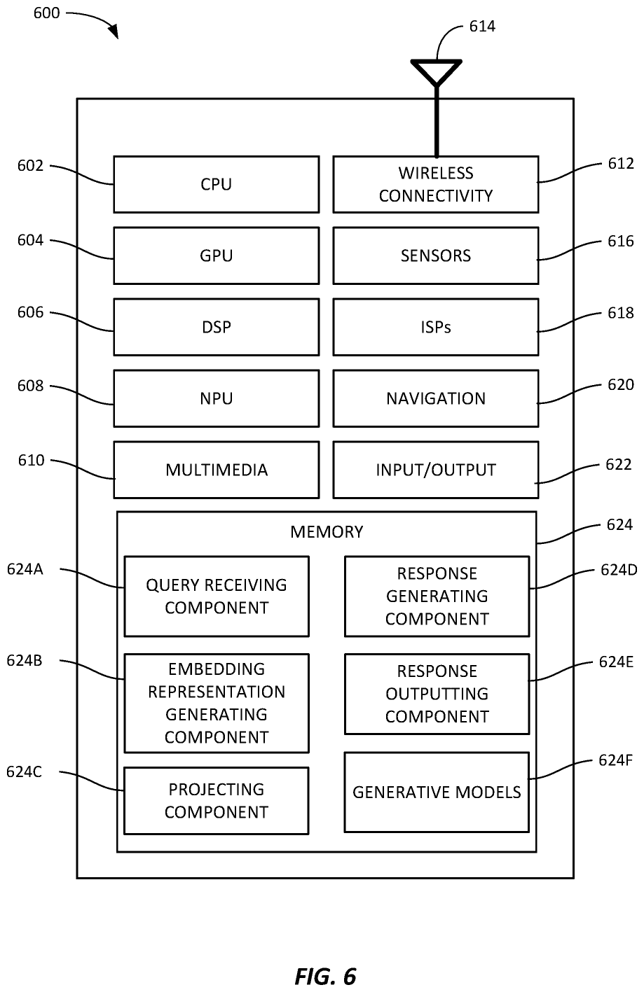

FIG. 6 depicts an example processing system 600 for generating a response to an input query using a large generative artificial intelligence model and a small generative artificial intelligence model, such as described herein for example with respect to FIG. 5.

The processing system 600 includes a central processing unit (CPU) 602, which in some examples may be a multi-core CPU. Instructions executed at the CPU 602 may be loaded, for example, from a program memory associated with the CPU 602 or may be loaded from a memory partition (e.g., of memory 624).

The processing system 600 also includes additional processing components tailored to specific functions, such as a graphics processing unit (GPU) 604, a digital signal processor (DSP) 606, a neural processing unit (NPU) 608, and a connectivity component 612.

An NPU, such as the NPU 608, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 608 is a part of one or more of the CPU 602, the GPU 604, and/or the DSP 606. These may be located on a user equipment (UE) in a wireless communication system or another computing device.

In some examples, a connectivity component 612 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 612 may be further coupled to one or more antennas (not shown).

In some examples, one or more of the processors of the processing system 600 may be based on an ARM or RISC-V instruction set.

The processing system 600 also includes a memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes a query receiving component 624A, an embedding representation generating component 624B, a projecting component 626C, a response generating component 624D, a response outputting component 624E, and generative models 624F. The depicted components, and others not depicted, may be configured to perform various aspects of the methods described herein.

Generally, the processing system 600 and/or components thereof may be configured to perform the methods described herein.

### Example Clauses

Implementation details of various aspects of the present disclosure are described in the following numbered clauses:

Clause 1: A processor-implemented method, comprising: receiving an input query for processing; generating, using a first generative artificial intelligence model, an embedding representation of the received input query in a first dimensionality; projecting the embedding representation of the received input query into a projected representation of the received input query, wherein the projected representation comprises a representation in a second dimensionality; generating a response to the received input query using a second generative artificial intelligence model and the projected representation; and outputting the generated response.

Clause 2: The method of Clause 1, wherein the first generative artificial intelligence model comprises a model including a larger number of parameters than a number of parameters included in the second generative artificial intelligence model.

Clause 3: The method of Clause 1 or 2, wherein the first generative artificial intelligence model and the second generative artificial intelligence model comprise models trained together on a same target task such that the first generative artificial intelligence model and the second generative artificial intelligence model are trained on a same number of tokens.

Clause 4: The method of any of Clauses 1 through 3, wherein generating the response using the second generative artificial intelligence model and the projected representation comprises autoregressively generating a first set of tokens including a threshold number of tokens.

Clause 5: The method of Clause 4, further comprising: generating, using the first generative artificial intelligence model, an updated embedding representation, the updated embedding representation comprising an embedding of the received input query and the generated first set of tokens in the first dimensionality; projecting the updated embedding representation into a projected updated embedding representation of the received input query and the generated first set of tokens in the second dimensionality; and generating, using the second generative artificial intelligence model and the projected updated embedding representation, a second set of tokens including the threshold number of tokens.

Clause 6: The method of any of Clauses 1 through 5, wherein generating the response using the second generative artificial intelligence model and the projected representation comprises: generating one or more first tokens based on the projected representation; concatenating the projected representation and information related to the generated one or more first tokens; and generating a second token based on the concatenated projected representation and the information related to the generated one or more first tokens.

Clause 7: The method of Clause 6, wherein concatenating the projected representation and the information related to the generated one or more first tokens comprises concatenating the projected representation and embedding representations of the one or more first tokens.

Clause 8: The method of any of Clauses 1 through 7, wherein generating the response using the second generative artificial intelligence model and the projected representation comprises: generating one or more first tokens based on the projected representation; projecting a combination of the embedding representation and the one or more first tokens into a projected representation of the received input query and the one or more first tokens in the second dimensionality; and generating a second token based on the projected representation of the received input query and the one or more first tokens.

Clause 9: The method of any of Clauses 1 through 8, wherein: the first generative artificial intelligence model comprises a large language model trained to generate the embedding representation in the first dimensionality, and the second generative artificial intelligence model comprises a small language model trained to generate a response based on an input in the second dimensionality.

Clause 10: The method of any of Clauses 1 through 9, wherein the second dimensionality is smaller than the first dimensionality.

Clause 11: A processing system comprising: a memory having executable instructions stored thereon; and one or more processors coupled to the memory and configured to execute the executable instructions to cause the processing system to perform the method of any of Clauses 1 through 10.

Clause 12: A processing system comprising means for performing the method of any of Clauses 1 through 10.

Clause 13: A computer-readable medium having instructions stored thereon which, when executed by one or more processors, cause the one or more processors to perform the method of any of Clauses 1 through 10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system, comprising:
at least one memory having executable instructions stored thereon; and
one or more processors configured to execute the executable instructions in order to cause the processing system to:
receive an input query for processing;
generate, using a first generative artificial intelligence model, an embedding representation of the received input query in a first dimensionality;
project the embedding representation of the received input query into a projected representation of the received input query, wherein the projected representation comprises a representation in a second dimensionality;
generate a response to the received input query using a second generative artificial intelligence model and the projected representation; and
output the generated response.

2. The processing system of claim 1, wherein the first generative artificial intelligence model comprises a model including a larger number of parameters than a number of parameters included in the second generative artificial intelligence model.

3. The processing system of claim 1, wherein the first generative artificial intelligence model and the second generative artificial intelligence model comprise models trained together on a same target task such that the first generative artificial intelligence model and the second generative artificial intelligence model are trained on a same number of tokens.

4. The processing system of claim 1, wherein to generate the response using the second generative artificial intelligence model and the projected representation, the one or more processors are configured to cause the processing system to autoregressively generate a first set of tokens including a threshold number of tokens.

5. The processing system of claim 4, wherein the one or more processors are further configured to cause the processing system to:
generate, using the first generative artificial intelligence model, an updated embedding representation, the updated embedding representation comprising an embedding of the received input query and the generated first set of tokens in the first dimensionality;
project the updated embedding representation into a projected updated embedding representation of the received input query and the generated first set of tokens in the second dimensionality; and
generate, using the second generative artificial intelligence model and the projected updated embedding representation, a second set of tokens including the threshold number of tokens.

6. The processing system of claim 1, wherein to generate the response using the second generative artificial intelligence model and the projected representation, the one or more processors are configured to cause the processing system to:
generate one or more first tokens based on the projected representation;
concatenate the projected representation and information related to the generated one or more first tokens; and
generate a second token based on the concatenated projected representation and the information related to the generated one or more first tokens.

7. The processing system of claim 6, wherein to concatenate the projected representation and the information related to the generated one or more first tokens, the one or more processors are configured to cause the processing system to concatenate the projected representation and embedding representations of the one or more first tokens.

8. The processing system of claim 1, wherein to generate the response using the second generative artificial intelligence model and the projected representation, the one or more processors are configured to cause the processing system to:
generate one or more first tokens based on the projected representation;
project a combination of the embedding representation and the one or more first tokens into a projected representation of the received input query and the one or more first tokens in the second dimensionality; and
generate a second token based on the projected representation of the received input query and the one or more first tokens.

9. The processing system of claim 1, wherein:
the first generative artificial intelligence model comprises a large language model trained to generate the embedding representation in the first dimensionality, and
the second generative artificial intelligence model comprises a small language model trained to generate a response based on an input in the second dimensionality.

10. The processing system of claim 1, wherein the second dimensionality is smaller than the first dimensionality.

11. A processor-implemented method, comprising:
receiving an input query for processing;
generating, using a first generative artificial intelligence model, an embedding representation of the received input query in a first dimensionality;
projecting the embedding representation of the received input query into a projected representation of the received input query, wherein the projected representation comprises a representation in a second dimensionality;
generating a response to the received input query using a second generative artificial intelligence model and the projected representation; and
outputting the generated response.

12. The method of claim 11, wherein the first generative artificial intelligence model comprises a model including a larger number of parameters than a number of parameters included in the second generative artificial intelligence model.

13. The method of claim 11, wherein the first generative artificial intelligence model and the second generative artificial intelligence model comprise models trained together on a same target task such that the first generative artificial intelligence model and the second generative artificial intelligence model are trained on a same number of tokens.

14. The method of claim 11, wherein generating the response using the second generative artificial intelligence model and the projected representation comprises autoregressively generating a first set of tokens including a threshold number of tokens.

15. The method of claim 14, further comprising:
generating, using the first generative artificial intelligence model, an updated embedding representation, the updated embedding representation comprising an embedding of the received input query and the generated first set of tokens in the first dimensionality;
projecting the updated embedding representation into a projected updated embedding representation of the received input query and the generated first set of tokens in the second dimensionality; and
generating, using the second generative artificial intelligence model and the projected updated embedding representation, a second set of tokens including the threshold number of tokens.

16. The method of claim 11, wherein generating the response using the second generative artificial intelligence model and the projected representation comprises:
generating one or more first tokens based on the projected representation;
concatenating the projected representation and information related to the generated one or more first tokens; and
generating a second token based on the concatenated projected representation and the information related to the generated one or more first tokens.

17. The method of claim 16, wherein concatenating the projected representation and the information related to the generated one or more first tokens comprises concatenating the projected representation and embedding representations of the one or more first tokens.

18. The method of claim 11, wherein generating the response using the second generative artificial intelligence model and the projected representation comprises:
generating one or more first tokens based on the projected representation;
projecting a combination of the embedding representation and the one or more first tokens into a projected representation of the received input query and the one or more first tokens in the second dimensionality; and
generating a second token based on the projected representation of the received input query and the one or more first tokens.

19. The method of claim 11, wherein:
the first generative artificial intelligence model comprises a large language model trained to generate the embedding representation in the first dimensionality, and
the second generative artificial intelligence model comprises a small language model trained to generate a response based on an input in the second dimensionality.

20. The method of claim 11, wherein the second dimensionality is smaller than the first dimensionality.

21. A processing system, comprising:
means for receiving an input query for processing;
means for generating, using a first generative artificial intelligence model, an embedding representation of the received input query in a first dimensionality;
means for projecting the embedding representation of the received input query into a projected representation of the received input query, wherein the projected representation comprises a representation in a second dimensionality;
means for generating a response to the received input query using a second generative artificial intelligence model and the projected representation; and
means for outputting the generated response.

22. The processing system of claim 21, wherein the first generative artificial intelligence model comprises a model including a larger number of parameters than a number of parameters included in the second generative artificial intelligence model.

23. The processing system of claim 21, wherein the first generative artificial intelligence model and the second generative artificial intelligence model comprise models trained together on a same target task such that the first generative artificial intelligence model and the second generative artificial intelligence model are trained on a same number of tokens.

24. The processing system of claim 21, wherein the means for generating the response using the second generative artificial intelligence model and the projected representation comprise means for autoregressively generating a first set of tokens including a threshold number of tokens.

25. The processing system of claim 24, further comprising:
means for generating, using the first generative artificial intelligence model, an updated embedding representation, the updated embedding representation comprising an embedding of the received input query and the generated first set of tokens in the first dimensionality;
means for projecting the updated embedding representation into a projected updated embedding representation of the received input query and the generated first set of tokens in the second dimensionality; and
means for generating, using the second generative artificial intelligence model and the projected updated embedding representation, a second set of tokens including the threshold number of tokens.

26. The processing system of claim 21, wherein the means for generating the response using the second generative artificial intelligence model and the projected representation comprise:
means for generating one or more first tokens based on the projected representation;
means for concatenating the projected representation and information related to the generated one or more first tokens; and
means for generating a second token based on the concatenated projected representation and the information related to the generated one or more first tokens.

27. The processing system of claim 26, wherein the means for concatenating the projected representation and the information related to the generated one or more first tokens comprise means for concatenating the projected representation and embedding representations of the one or more first tokens.

28. The processing system of claim 21, wherein the means for generating the response using the second generative artificial intelligence model and the projected representation comprise:
means for generating one or more first tokens based on the projected representation;
means for projecting a combination of the embedding representation and the one or more first tokens into a projected representation of the received input query and the one or more first tokens in the second dimensionality; and
means for generating a second token based on the projected representation of the received input query and the one or more first tokens.

29. The processing system of claim 21, wherein:
the first generative artificial intelligence model comprises a large language model trained to generate the embedding representation in the first dimensionality, and
the second generative artificial intelligence model comprises a small language model trained to generate a response based on an input in the second dimensionality.

30. A non-transitory computer-readable medium having executable instructions stored thereon which, when executed by one or more processors, cause the one or more processors to perform an operation comprising:
receiving an input query for processing;
generating, using a first generative artificial intelligence model, an embedding representation of the received input query in a first dimensionality;
projecting the embedding representation of the received input query into a projected representation of the received input query, wherein the projected representation comprises a representation in a second dimensionality, and wherein the second dimensionality is smaller than the first dimensionality;
generating a response to the received input query using a second generative artificial intelligence model and the projected representation; and
outputting the generated response.
